(19) United States
(12) Patent Application Publication
(10) Pub. No.: US 2011/0231641 A1
(43) Pub. Date: Sep. 22, 2011

(54) INFORMATION-PROCESSING APPARATUS AND METHOD OF STARTING INFORMATION-PROCESSING APPARATUS

(75) Inventor: Yuichi MUSHA, Kawasaki (JP)

(73) Assignee: Fujitsu Limited, Kawasaki (JP)

(21) Appl. No.: 13/013,047

(22) Filed: Jan. 25, 2011

(30) Foreign Application Priority Data
Mar. 19, 2010 (JP) 2010-63925

(51) Int. Cl. G06F 15/177

(52) U.S. Cl. 713/2

(57) ABSTRACT

An information-processing apparatus includes a main system that presents a function as the information-processing apparatus and has a function of acquiring time information from a time server, and a subsystem managing the main system. The main system starts up in start mode which is either an ordinary-start mode or a specified mode provided to acquire the synchronized time information from the time server based on a start-mode instruction issued from the subsystem. The subsystem starts up the main system in the specified mode when starting the main system being at rest, wherein the subsystem revises management-system time obtained from a clock device, which is controlled by the subsystem, based on the synchronized time information acquired through the main system started in the specified mode, and restarts the main system in the ordinary-start mode by determining the revised management-system time to be initial time used to start the main system.

### CROSS-REFERENCE TO RELATED APPLICATION

This application is based upon and claims the benefit of priority of the prior Japanese Patent Application No. 2010-63925, filed on Mar. 19, 2010, the entire contents of which are incorporated herein by reference.

### FIELD

The embodiments discussed herein are related to a starting method provided to start a main system presenting a predetermined function as an information-processing apparatus through a subsystem managing the main system in an information-processing apparatus including the main system and the subsystem.

### BACKGROUND

Information-processing apparatuses having a main system presenting a predetermined function as the information-processing apparatus and a subsystem managing the main system have been available, as servers or the like. FIG. 11 illustrates an exemplary configuration of the above-described information-processing apparatus. That is, an information-processing apparatus 1 illustrated in FIG. 11 includes a subsystem 10, a plurality of main systems 21, 22, and 23, a clock device 30, and a battery 31. Although the three main systems are provided according to the system configuration of the information-processing apparatus 1 illustrated in FIG. 11, the number of the main systems may be two and/or a larger number including several tens, several hundreds, etc. (ditto for embodiments that will be described later).

Each of the main systems 21 to 23 is a system obtained by executing a specified operating system (OS) on a calculation-processing device such as a central processing unit (CPU). Usually, each of the main systems 21 to 23 is started through the subsystem 10. Further, at least part of the main systems is connected to a communication network including, for example, a local area network (LAN). A LAN connected to the main system is referred to as an “operation LAN” for convenience. In FIG. 11, each of the main systems 21 to 23 is connected to an operation LAN 5.

The subsystem 10 is started only by inserting a power plug 32 of the information-processing apparatus 1 into a commercial power receptacle and/or turning a power switch to “On”. The subsystem 10 is provided mainly for managing the main systems 21 to 23 via a bus 15 provided in the information-processing apparatus 1. Here, the bus 15 may be a high-speed serial bus and/or a parallel bus. Otherwise, the bus 15 may be a communication line operating under a predetermined protocol.

The subsystem 10 is connected to a specified communication network 6 including a LAN or the like. A LAN 6 connected to the subsystem 10 will be referred to as a “management LAN” for convenience. The subsystem 10 is operated through, for example, a personal-computer (PC) terminal (not shown) connected to the management LAN 6.

The information-processing apparatus 1 includes a single clock device 30 controlled through the subsystem 10. The clock device 30 includes a time-of-day (TOD) clock, a real-time-clock (RTC) device, and so forth. When the power of the information-processing apparatus 1 is turned off, the clock device 30 such as the TOD clock is powered from the battery 31 connected to the clock device 30.

According to the above-described information-processing apparatus 1, the subsystem 10 needs to acquire accurate time information to manage each of the main systems 21 to 23. When the subsystem 10 does not acquire the accurate time information, problems relating to the internal time of the main system, such as time-hops, the time retrogression, and so forth may occur when the main system is started through the subsystem, as will be described later. For example, when the subsystem 10 starts the main system 21, the main system 21 is started upon acquiring information about the initial time from the subsystem 10. In many cases, the main system 21 accesses a network-time-protocol (NTP) server 3 via the operation LAN 5 connected to the main system 21 while and/or after being started, and synchronizes the internal time of the main system 21 with the accurate time of the NTP server 3. If the first initial time acquired from the subsystem 10 is then different from the accurate time, the problems including the time-hops, the time retrogression, and so forth may occur.

FIG. 12 illustrates operations that are performed when the main system 21 is started through the subsystem 10. FIG. 12 does not illustrate system components that are provided in the information-processing apparatus 1 except for the subsystem 10 and the main system 21. The main system 21 includes a boot loader 40 provided to start the main system 21 and a domain OS 50. The boot loader 40 is a program which is 1 megabyte (MB) or around in size, for example, and has an exemplary configuration illustrated in FIG. 13. As illustrated in FIG. 13, the boot loader 40 includes a boot-loader basic function section 40-1, a network library 40-2, various libraries 40-3, and a hardware-control driver 40-4, and the function of booting the domain OS 50 through the above-described components. The program of the boot loader 40 may be stored in a read-only memory (ROM) provided in the main system 1 in advance. Otherwise, predetermined content data of the program may be transmitted from the subsystem-side and written into a random-access memory (RAM) provided in the main system, the RAM being provided to store command code (ditto for embodiments that will be described later).

When the subsystem 10 cancels the system reset of the main system 21, predetermined initial diagnosis processing (described later) or the like is performed for the main system 21, and the boot loader 40 of the main system 21 is started. The boot-loader basic function section 40-1 of the boot loader 40 controls various types of hardware 21-10 provided in the main system 21 through the network library 40-2, the various function libraries 40-3, and the hardware-control driver 40-4, and starts the domain OS 50.

When the domain OS 50 of the main system 21 is started through the boot loader 40, the main system 21 accesses the NTP server 3 via the operation LAN 5, and synchronizes the internal time of the main system 21 with the time of the NTP server. From then on, the main system 21 accesses the NTP server on a regular basis and ticks the time in synchronization with the NTP server.

When the time of the clock device 30 such as the TOD clock, which is the reference time of the subsystem 10, is different from the accurate time, a problem may occur when the main system 21 is started. For example, when the main system 21 is started based on inaccurate initial time information transmitted from the subsystem 10 and the main system 1 accesses the NTP server 3 and synchronizes the internal time of the main system 21 with the time of the NTP server 3 after the main system 21 is started, the time-hops and/or the time retrogression may occur. The occurrence of the time-hops and/or the time retrogression may adversely affect a software program operating on the main system. Particularly, although clustering software or the like provided to perform management including making an information-processing system including at least two main systems redundant, the error detection, the job-taking over, and so forth is software operating on the main system, the operation of the clustering software is hindered by the occurrence of the time-hops, etc. This is because the clustering software or the like is started immediately after the main system boots up, and performs various types of processing with reference to the internal time of the main system.

On the other hand, the time of the system 10 being generated based on the clock device 30 including the TOD clock or the like is often different from the accurate time by as much as 10 seconds or around per month. For example, when starting the main system 21 after each of the main systems 21 to 23 is at rest over a long time period, the time of the subsystem 10 have to be synchronized with that of the NTP server before starting the main system 21. Otherwise, the time-hops or the like may occur when the main system 21 is started.

Accordingly, an NTP server 4 has been provided in the management LAN 6 connected to the subsystem 10 and/or the commonality of the management LAN 6 and the operation LAN 5 has been introduced, for example.

Each of the following related arts has been used as the method of time-synchronizing a plurality of systems and/or information-processing apparatuses.

Each of Japanese Laid-open Patent Publication No. 2005-135063, Japanese Laid-open Patent Publication No. 2008-102713, Japanese Laid-open Patent Publication No. 2005-71082, and Japanese Laid-open Patent Publication No. 2000-349791 is an example of related art.

As described above, a system configuration allowing for accessing from the subsystem 10 to the NTP server 3 has been used to make the time of the subsystem 10 accurate. According to the above-described system, for example, the NTP server 4 is provided in the management LAN 6 connected to the subsystem 10 which is directly connected to the operation LAN 5.

However, when the subsystem 10 managing the information-processing apparatus 1 is connected to a communication network connected to the NTP server, special-purpose security countermeasures may be needed to ensure the security of the subsystem 10. Therefore, for constructing the system of the information-processing apparatus 1 according to a simple and safe method, the management LAN 6 connected to the subsystem 10 is preferably a special-purpose communication line that is separated from the operation LAN 5 and that is used only for managing the information-processing apparatus 1. Further, since the system-construction cost is increased when the NTP server 4 is connected to the management LAN 6, which is the communication network different from the operation LAN 5, it is preferable not to provide the NTP server 4 in the management LAN 6.

Accordingly, when each of the main systems 21 to 23 is started through the subsystem 10 connected to the management LAN 6 separated from the operation LAN connected to the NTP server or the like, the subsystem 10 is preferably to acquire the accurate time through the use of the NTP server 3 connected to the operation LAN 5.

### SUMMARY

An information-processing apparatus includes a main system that presents a function as the information-processing apparatus and has a function of acquiring time information from a time server, and a subsystem managing the main system. The main system starts up in start mode which is either an ordinary-start mode or a specified mode provided to acquire the synchronized time information from the time server based on a start-mode instruction issued from the subsystem. The subsystem starts up the main system in the specified mode when starting the main system being at rest, wherein the subsystem revises management-system time obtained from a clock device, which is controlled by the subsystem, based on the synchronized time information acquired through the main system started in the specified mode, and restarts the main system in the ordinary-start mode by determining the revised management-system time to be initial time used to start the main system.

The object and advantages of the various embodiments will be realized and attained by means of the elements and combinations particularly pointed out in the claims.

It is to be understood that both the foregoing general description and the following detailed description are exemplary and explanatory and are not restrictive of the various embodiments, as claimed.

### BRIEF DESCRIPTION OF THE DRAWINGS

FIG. 1 illustrates an exemplary configuration of an information-processing apparatus according to an embodiment;

FIG. 2 illustrates an exemplary configuration achieved at the main-system starting time according to an embodiment;

FIG. 3 illustrates an exemplary configuration of a boot loader according to an embodiment;

FIG. 4 illustrates an exemplary configuration of an NTP library according to an embodiment;

FIG. 5 illustrates an exemplary main-system starting flow according to an embodiment;

FIG. 6 illustrates an exemplary flow of operations that are performed through a subsystem at the main-system starting time according to an embodiment;

FIG. 7 illustrates an exemplary flow of operations that are performed through a main system in time-acquisition mode at the main-system starting time according to an embodiment;

FIG. 8 illustrates an exemplary flow of operations that are performed through the main system in ordinary-start mode at the main-system starting time according to an embodiment;

FIG. 9 illustrates a second exemplary main-system starting flow according to an embodiment;

FIG. 10 illustrates a third exemplary main-system starting flow according to an embodiment;

FIG. 11 illustrates an exemplary configuration of a known information-processing apparatus;

FIG. 12 illustrates a known configuration achieved at the main-system starting time; and

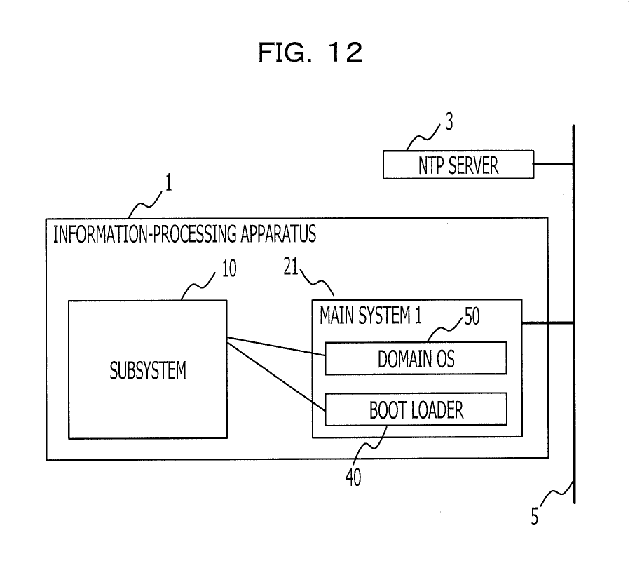

FIG. 13 illustrates an exemplary configuration of a known boot loader.

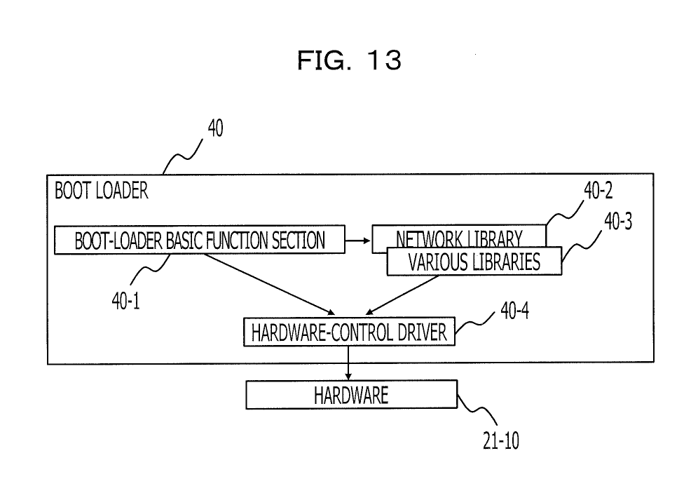

### DESCRIPTION OF EMBODIMENTS

Hereinafter, embodiments will be described in detail.

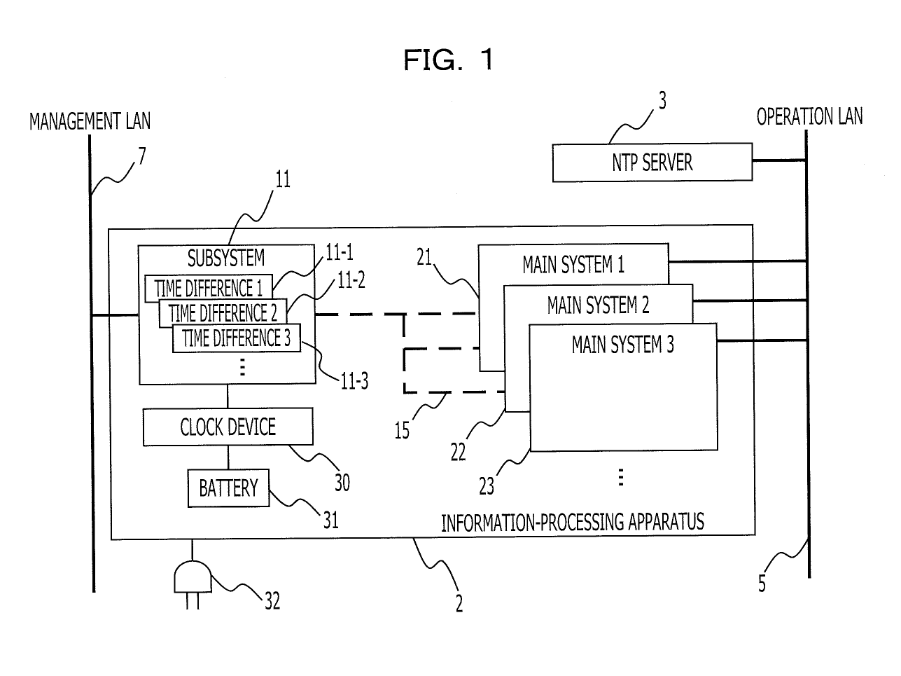

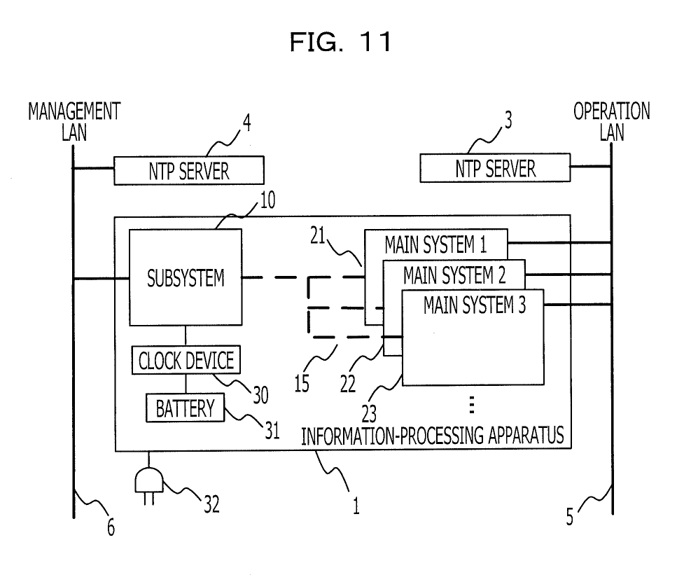

FIG. 1 illustrates an exemplary configuration of an information-processing apparatus 2 according to an embodiment. A network-time-protocol (NTP) server is not connected to a management local area network (LAN) 7 connected to a subsystem 11 of the information-processing apparatus 2 illustrated in FIG. 1. The management LAN 7 and an operation LAN 5 are independent communication networks that are not connected to each other. Since other components that are illustrated in FIG. 1 and that are designated by the same reference numerals as those of components that are illustrated in FIG. 11 are equivalent to the components that are illustrated in FIG. 11, the descriptions of the other components are omitted.

The subsystem 11 illustrated in FIG. 1 includes circuits 11-1, 11-2, and 11-3 that are provided to store time-difference information which is information about differences between the times of individual main systems 21, 22, and 23, and a system time acquired through a clock device 30. Although FIG. 1 illustrates the three circuits 11-1 to 11-3, where each of which is provided to store the time-difference information, the number of the above-described circuits may be the same as that of the main systems. Further, each of the circuits that are provided to store the time-difference information may be configured to store information about the date and time when the time-difference information is updated so that the update frequency and/or the date and time of the update can be confirmed. The way the time-difference information is dealt with will be described later.

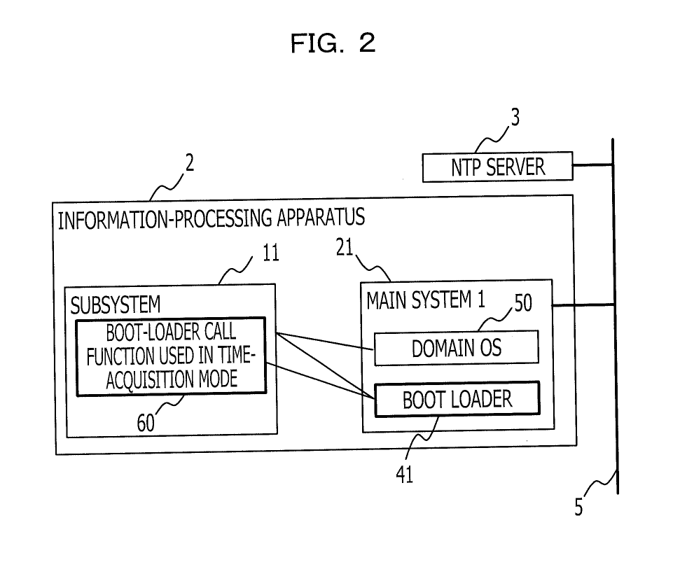

FIG. 2 illustrates an exemplary configuration of the information-processing apparatus 2 according to an embodiment, the configuration being achieved when the main system 21 is started. Operations that are performed when the main system 21 is started through the subsystem 11 will be described with reference to FIG. 2. The main system 21 illustrated in FIG. 2 includes a boot loader 41 different from the known boot loader 40. The boot loader 41 illustrated in FIG. 2 has the function of operating in time-acquisition mode provided to access and acquire time information from the NTP server 3 connected to the operation LAN 5 based on a start instruction issued from the subsystem 11 in addition to ordinary-start mode provided to start the main system 21. The subsystem 11 includes a boot-loader call function 60 used in the time-acquisition mode, which is the function of starting the boot loader 41 in the time-acquisition mode.

Start mode indicating whether the main system 1 is to be started in the ordinary-start mode or in the time-acquisition mode is set to a storage circuit including a register or the like accessible by the boot loader 41 of the main system 1 through the boot-loader call function 60 of the subsystem 11 before the main system 1 is started. The storage circuit (not shown) storing information about the above-described start mode may be provided in the subsystem and/or a peripheral device of each of the main systems. When the storage circuit storing the start-mode information is provided in the subsystem 11, each of the main systems accesses the above-described storage circuit via a bus 15 or the like. Then, the boot loader 41 of the main system 1 refers to the value of the storage circuit storing the start-mode information at the start time, and obtains information indicating whether the main system 1 is to be started in the ordinary-start mode or in the time-acquisition mode.

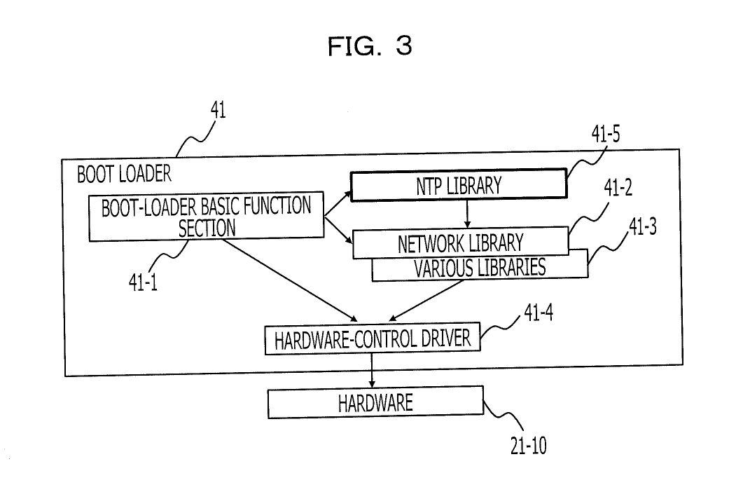

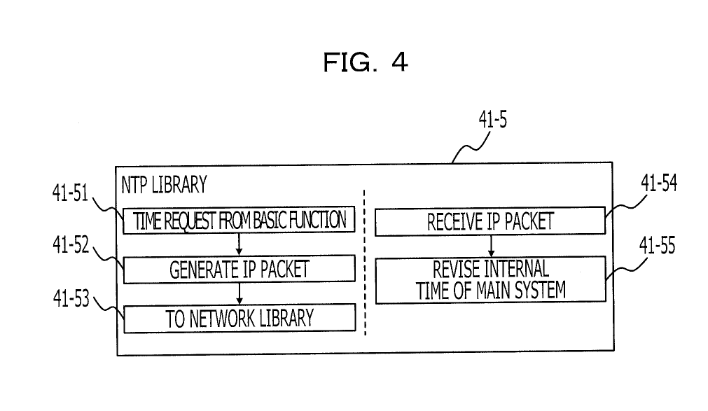

The function of the time-acquisition mode of the boot loader 41 is achieved by providing an NTP library 41-5 having the function of accessing the NTP server 3 in the boot loader 41 as illustrated in FIG. 3. The NTP library 41-5 has an interface function provided to acquire the time information from the NTP server 3. More specifically, the interface function is achieved through an exemplary configuration illustrated in FIG. 4. Processing performed through the NTP library 41-5 can be roughly be divided into processing performed to transmit information about a time-acquisition request to the NTP server 3 (41-51, 41-52, and 41-53) and processing performed to, for example, receive the time information transmitted from the NTP server 3 (41-54 and 41-55).

Upon receiving the time-acquisition-request information transmitted from a boot-loader basic function section 41-1 (41-51), the NTP library 41-5 generates an IP packet used to transmit the time-acquisition-request information to the NTP server 3 (41-52), and transmits the generated IP packet to a network library 41-2 (41-53). Here, the term “IP” is an abbreviation of the Internet Protocol and the term “IP packet” denotes a set of data items that are transmitted and/or received on the Internet. The network library 41-2 controls a hardware circuit 21-10 provided in the main system 21 via a hardware-control driver 41-4, and transmits the generated IP packet to the NTP server 3 connected to the operation LAN 5. Then, the NTP library 41-5 receives an IP packet including the time information, the IP packet being returned from the NTP server 3 (41-54), and performs processing to revise the internal time of the main system 21 (41-55).

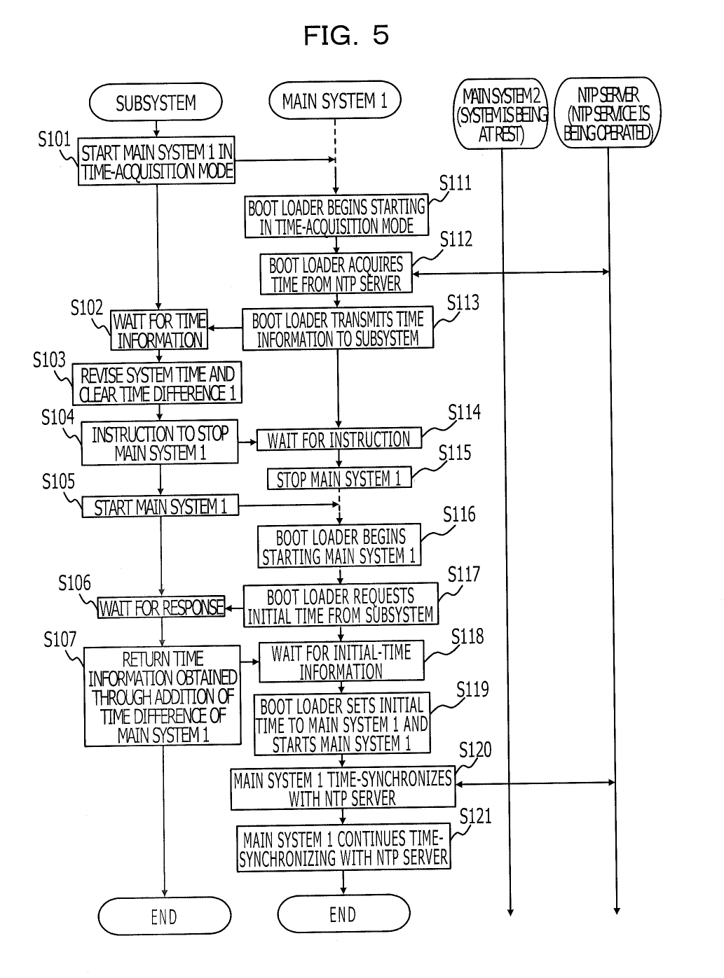

FIG. 5 illustrates an exemplary main-system starting flow according to an embodiment. FIG. 5 illustrates the subsystem 11, and the main systems 21 and 22 while other main systems are not considered. Further, the subsystem 11, the main systems 21 and 22, and the NTP server 3 are simply referred to as the subsystem, the main systems 1 and 2, and the NTP server in FIG. 5.

In FIG. 5, the NTP server is connected only to the operation LAN 5 connected to the main systems 1 and 2, and is operated throughout the entire flow illustrated in FIG. 5. Further, each of the main systems 1 and 2 is at rest. When starting the main system 1 through the subsystem in that state, the time of the subsystem needs to be revised to the accurate time synchronized with the NTP server in the first place. After that, the main system 1 is started. Hereinafter, the exemplary main-system starting flow will be described with reference to FIG. 5.

First, when the information-processing apparatus 2 is started by, for example, inserting a power plug 32 of the information-processing apparatus 2 into a commercial power receptacle, the subsystem acquires information about the initial time from the clock device 30 (not shown in FIG. 5). Then, the subsystem ticks the system time thereof through a timer interruption or the like made through a timer circuit provided in the subsystem. Here, the time of the subsystem, the time being measured when the information-processing apparatus 2 is started, may be different from the accurate time with the precision corresponding to a monthly rate of ten seconds or around as described above.

The subsystem starts the main system 1 in the time-acquisition mode as operation (S101) illustrated in FIG. 5 to revise the time of the subsystem based on the time synchronized with the NTP server connected to the operation LAN. At that time, the subsystem transmits information about the then current subsystem time to the main system 1 as the initial-time information and starts the main system 1 in the time-acquisition mode. When the boot loader 41 of the main system 1 perceives that the main system 1 is started through the subsystem in the time-acquisition mode, the boot loader 41 begins starting the main system 1 in the time-acquisition mode as operation (S111).

Upon being started in the time-acquisition mode, the boot loader 41 of the main system 1 determines the initial time, where information about the initial time is transmitted from the subsystem, to be the time of its own in the first place, and ticks the time through a timer interruption made through a timer circuit (not shown) or the like provided in the main system 1. After that, the boot loader 41 acquires the time information from the NTP server through the above-described NTP library 41-5 (S112).

The main system 1 transmits the time information acquired by accessing the NTP server to the subsystem (S113). More specifically, the main system 1 transmits the time information indicating the time synchronized with the NTP server to the subsystem via the bus 15 provided in the information-processing apparatus 2. Upon receiving the time information transmitted from the main system 1, the subsystem calculates the time difference between the time information transmitted from the main system 1 and the time information of the subsystem through a hardware circuit and/or specified program processing, and writes information about the time difference into the time-difference storage circuit 11-1. The subsystem can obtain the information about the time synchronized with the NTP server by adding the time-difference information stored in the time-difference storage circuit 11-1 to the time information of the subsystem. Further, when the time of the subsystem can be read from the main-system-1 side, it may be arranged that the difference between the time acquired from the NTP server through the program processing performed in the main system 1 and the time of the subsystem is obtained, and information about the calculated time difference is written from the main-system-1 side into the time-difference storage circuit 11-1 (same as above).

After transmitting the time information to the subsystem as operation (S113), the main system 1 waits for an instruction issued from the subsystem as operation (S114).

Upon being notified of the time information transmitted from the main system 1, the subsystem which had been waiting for the time information as operation (S102) revises the time of the subsystem based on the transmitted time information, and clears a time difference 1 which is information about the difference between the time of the main system 1 and the time of the subsystem (S103), the time difference 1 being held in the subsystem. At that time, the time of the subsystem is revised to the time synchronized with the NTP server. Further, it may be arranged that the time difference 1 may be information about the difference between the time of the main system 1 and that of the subsystem, where the difference information is stored on the order of seconds.

The processing corresponding to the operation (S103) allows for synchronizing the time of the subsystem with that of the NTP server. Therefore, the subsystem transmits information about a stop instruction to the main system 1 as operation (S104) to start the main system 1 in the ordinary-start mode. Upon receiving the stop-instruction information transmitted from the subsystem (S104), the main system 1 stops the main system 1 (S115).

The subsystem perceives that the main system 1 is stopped through a specified system-monitoring means (not shown) and/or a timer counter (not shown) provided to measure a lapse of specified time, and starts the main system 1 in the ordinary-start mode (S105). After starting the main system 1 (S105), the subsystem waits for a response from the main system 1 (S106).

When the boot loader 41 of the main system 1 perceives that the subsystem transmits an instruction to start the main system 1 in the ordinary-start mode, the boot loader 41 starts booting a domain OS 50 of the main system 1 in the ordinary-start mode (S116). When starting the main system 1 in the ordinary-start mode, the domain OS 50 being started requests the initial-time information from the boot loader 41. Upon receiving information about the initial-time request issued from the domain OS 50, the boot loader 41 requests the initial-time information used to start the domain OS 50 from the subsystem (S117), and waits for the initial-time information transmitted from the subsystem (S118).

Upon receiving the initial-time-request information transmitted from the main system 1 (S117), the subsystem returns information about time obtained by adding the time difference 1 of the main system 1 to the time of the subsystem to the main system 1 as the initial time defined to start the main system 1 (S107). Since the time of the subsystem had already been revised to the time synchronized with the NTP server and the time difference 1 had already been cleared as the above-described operation (S103), the addition of the time difference 1 to the subsystem time may be omitted during operation (S107). That is, the subsystem may return the subsystem time revised through operation (S103) to the main system 1 as the initial time of the main system 1 as operation (S107).

Upon acquiring the initial-time information transmitted from the subsystem, the boot loader 41 of the main system 1 transmits the acquired initial-time information to the domain OS 50 of the main system 1 as the initial-time information, and starts the domain OS 50 (S119). When the boot loader 41 starts the domain OS 50, the main system 1 synchronizes the time with that of the NTP server (S120), and continues time-synchronizing with the NTP server on a regular basis (S121).

The above-described starting flow illustrated in FIG. 5 allows the subsystem to start the main system after acquiring information about the time synchronized with that of the NTP server connected to the operation LAN even though a specified main system is started through the subsystem in the state where each of the main systems is at rest.

FIG. 5 illustrates the exemplary flow performed in the state where each of the main systems 1 and 2 is at rest at first. However, if the time of the subsystem may not be synchronized with that of the NTP server even though the main system 2 is started, for example, the main system 1 may be started through a processing flow illustrated in FIG. 5. For example, when the main system 2 is not synchronized with the NTP server within a specified time period, the time of the main system 2 may be different from that of the NTP server. In that case, the subsystem time is not synchronized with that of the NTP server even though the subsystem time is revised based on information about the time of the main system 2. Consequently, the subsystem time needs to be revised to time synchronized with the NTP server before the main system 1 is started.

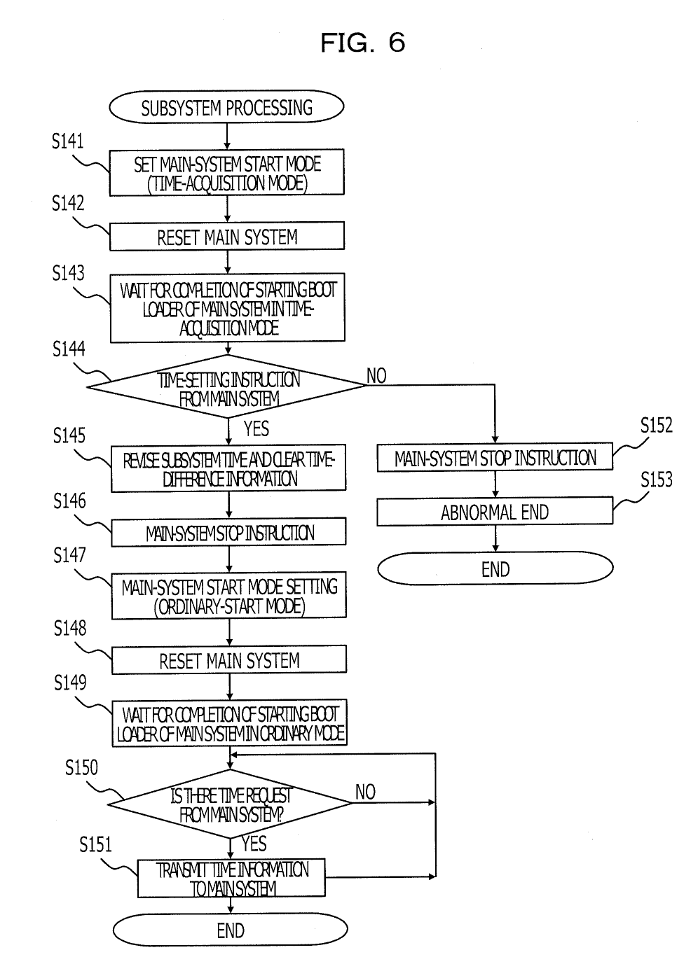

Operations that are performed through each of the subsystem and the main system 1, the operations being illustrated in FIG. 5, will be described in detail with reference to FIGS. 6, 7, and 8.

FIG. 6 is a flowchart illustrating operations that are performed through the subsystem according to an embodiment, the operations being performed in the main-system-starting flow illustrated in FIG. 5. When the time of the subsystem is not synchronized with that of the NTP server as illustrated in FIG. 5, the subsystem sets the start mode to the storage circuit storing information about the start mode so that the main system is started in the time-acquisition mode (S141). The main system may be notified of the instruction about whether or not the main system is to be started in the time-acquisition mode through the use of a specified control signal. Otherwise, the main system may be notified of the above-described instruction through specified information written into a memory area or the like that can be read through the main system.

Next, the subsystem performs reset processing to initialize the main system for starting (S142). More specifically, the subsystem initializes the main system by instructing a reset-control circuit provided to control the reset of the main system (not shown) to apply a reset signal to the main system. At that time, the subsystem may issue an wake-up instruction used to start the main system being at rest in place of the instruction to apply the reset signal to the main system, the instruction being transmitted from the subsystem, and the reset-control circuit may detect the wake-up instruction and generate the reset signal used to start the main system. When the reset is canceled after the main system is initialized due to the application of the reset signal which is externally transmitted from the reset-control circuit, the initialized main system starts the boot loader 41.

After resetting the main system (S142), the subsystem starts the boot loader 41 of the main system in the time-acquisition mode and waits until the acquisition of the time information from the NTP server is finished (S143).

After that, upon receiving a time-setting instruction transmitted from the boot loader 41 of the main system (Yes for operation (S144)), the subsystem revises the subsystem time and clears the time-difference information of the main system (S145). On the other hand, when the time-setting instruction is not transmitted from the boot loader 41 after a lapse of predetermined time (No for operation (S144)), the main system is not properly started due to the occurrence of some error. Therefore, the subsystem issues an instruction to stop the main system (S152). Then, the subsystem performs predetermined processing relating to the abnormal end. For example, the subsystem externally transmits information about the circumstances under which the error occurs as log information, and resets the main system (S153), and terminates the main-system start processing.

Upon receiving the time-setting instruction transmitted from the boot loader 41 of the main system (Yes for operation (S144)), the subsystem revises the subsystem time and clears the time-difference information of the main system for starting (S145). Since the subsystem acquires information about the time synchronized with the NTP server at that point in time, the subsystem temporarily issues an instruction to stop the main system (S146). The above-described main-system stop instruction may not be intended to stop supplying power to the main system. That is, only the function of the main system may be stopped so that the main system can be restarted immediately.

After that, the subsystem makes settings on the start mode provided to start the main system in the ordinary start mode (S147), performs the reset processing for the main system, and restarts the main system (S148). During the reset processing corresponding to operation (S148), the subsystem may instruct the reset-control circuit of the main system to initialize the entire main system and/or apply only a specified reset signal used to restart a CPU alone, which is provided in the main system. After performing the reset processing for the main system (S148), the subsystem waits until the boot loader 41 of the main system is started over a specified time period (S149).

The subsystem waits for a request for initial set time, the request being transmitted from the boot loader 41 of the main system (S149). Upon receiving the initial-set-time request (Yes for operation (S150)), the subsystem transmits initial-set-time information to the boot loader 41 (S151), and terminates the start processing performed for the main system. When the initial-set-time request is not transmitted from the boot loader 41 to the subsystem (No for operation (S150)), the subsystem waits for the transmission of the initial-set-time request while making loops (S150).

Since the subsystem waits for the initial-set-time request transmitted from the boot loader 41 of the main system as operation (S150), operation (S149) may be omitted.

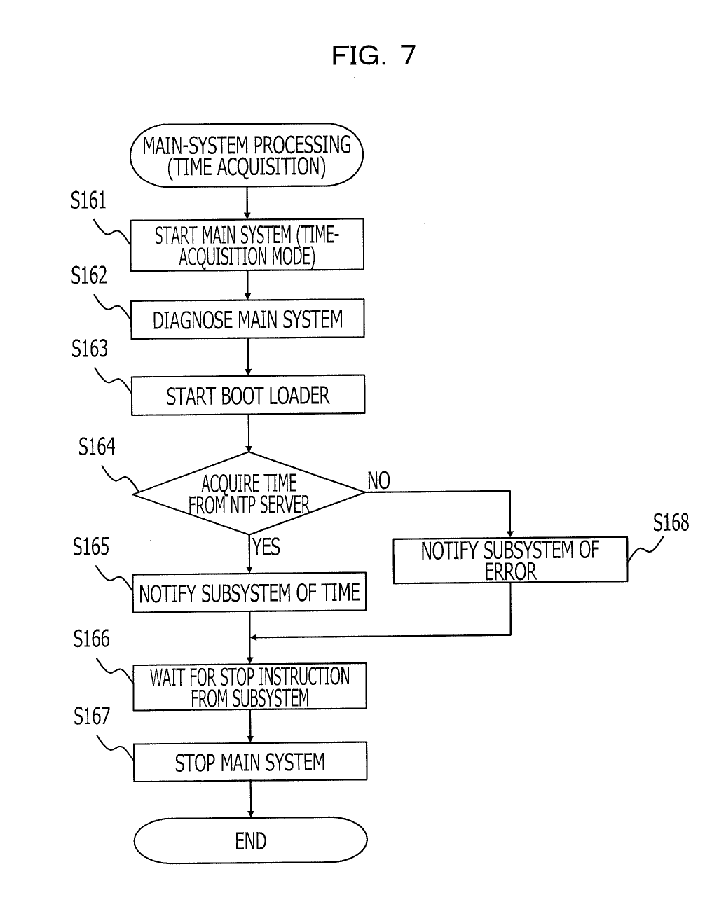

FIG. 7 is a flowchart illustrating operations that are performed through the main system in the time-acquisition mode according to an embodiment, where the operations are performed during the main-system starting flow illustrated in FIG. 5. Upon being started through the subsystem in the time-acquisition mode (S161), the main system performs, in the first place, diagnosis processing at the main-system starting time (S162). The diagnosis processing performed at the main-system starting time includes confirming whether or not a memory and/or each of various function circuits that are provided in the main system operates properly through a self-diagnostic program that had already been prepared in a read-only memory (ROM) or the like of the main system. Otherwise, predetermined content data of the self-diagnostic program may be transmitted from the subsystem-side and written into a random-access memory (RAM) or the like provided in the main system, the RAM or the like being provided to store command code. After that, the self-diagnostic program may be executed.

When an error is detected during the main-system diagnosis processing (S162), information about, for example, the circumstances under which the error occurs is externally transmitted as the log information, and the start processing performed for the main system is terminated (not shown). When no error is detected during the main-system diagnosis processing (S162), the boot loader 41 of the main system is started (S163). When the boot loader 41 is started in the time-acquisition mode, the boot loader 41 accesses the NTP server through the NTP library 41-5 illustrated in each of FIGS. 3 and 4, and acquires the time information (S164).

When the boot loader 41 can acquire the time information from the NTP server (Yes for operation (S164)), the boot loader 41 notifies the subsystem of the acquired time information (S165). On the other hand, when the time information is not acquired from the NTP server (No for operation (S164)), the boot loader notifies the subsystem of an error (S168).

After that, the main system waits for a stop instruction issued from the subsystem (S166), and performs stop processing (S167) upon receiving the stop instruction transmitted from the subsystem.

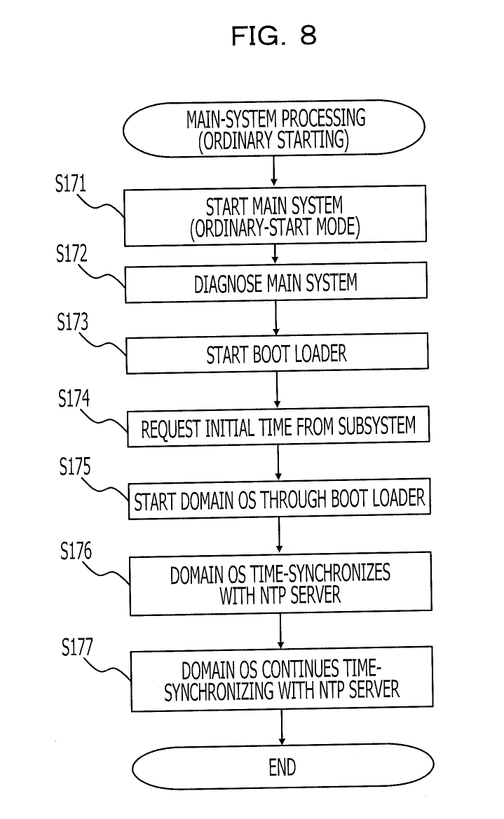

FIG. 8 is a flowchart illustrating operations that are performed through the main system in the ordinary-start mode according to an embodiment, the operations being performed in the main-system-starting flow illustrated in FIG. 5. When the main system is started in the ordinary-start mode (S171), the self-diagnostic program of the main system is executed (S172) as is the case with FIG. 7. When the result of the self diagnosis shows no error, the boot loader 41 is started in the ordinary-start mode (S173).

When the boot loader 41 is started in the ordinary-start mode, the boot loader 41 directly starts the domain OS 50 of the main system without accessing the NTP server, for example, as illustrated in FIG. 7. The boot loader 41 requests the initial-time information used to start the domain OS 50 from the subsystem in the first place (S174). At that point in time, the time of the subsystem is synchronized with that of the NTP server through the above-described processing illustrated FIG. 7. Therefore, the subsystem can send back information about the accurate time in response to the time-acquisition request issued from the boot loader 41.

After acquiring the initial-time information transmitted from the subsystem, the boot loader 41 starts the domain OS 50 of the main system (S175). When being started, the domain OS 50 synchronizes the time thereof with that of the NTP server (S176). Since the time of the domain OS 50 is synchronized with that of the NTP server at that point in time, problems including time-hops, the time retrogression, and so forth do not occur during the time-synchronization processing performed as operation (S176). After that, the domain OS 50 continues time-synchronizing with the NTP server at fixed time periods (S177).

Thus, in the present embodiment, the boot loader 41 of the main system is started in the time-acquisition mode and is made to access the NTP server so that information about the time synchronized with the NTP server is acquired in the case where the time of the subsystem is not synchronized with that of the NTP server when the main system is started through the subsystem. After the time of the subsystem is synchronized with that of the NTP server, the main system is started in the ordinary-start mode. Consequently, even though the NTP server is not connected to the management LAN 7 connected to the subsystem, the NTP server 3 is accessible via the management LAN 5 connected to the main system and the subsystem can acquire information about the time synchronized with the NTP server.

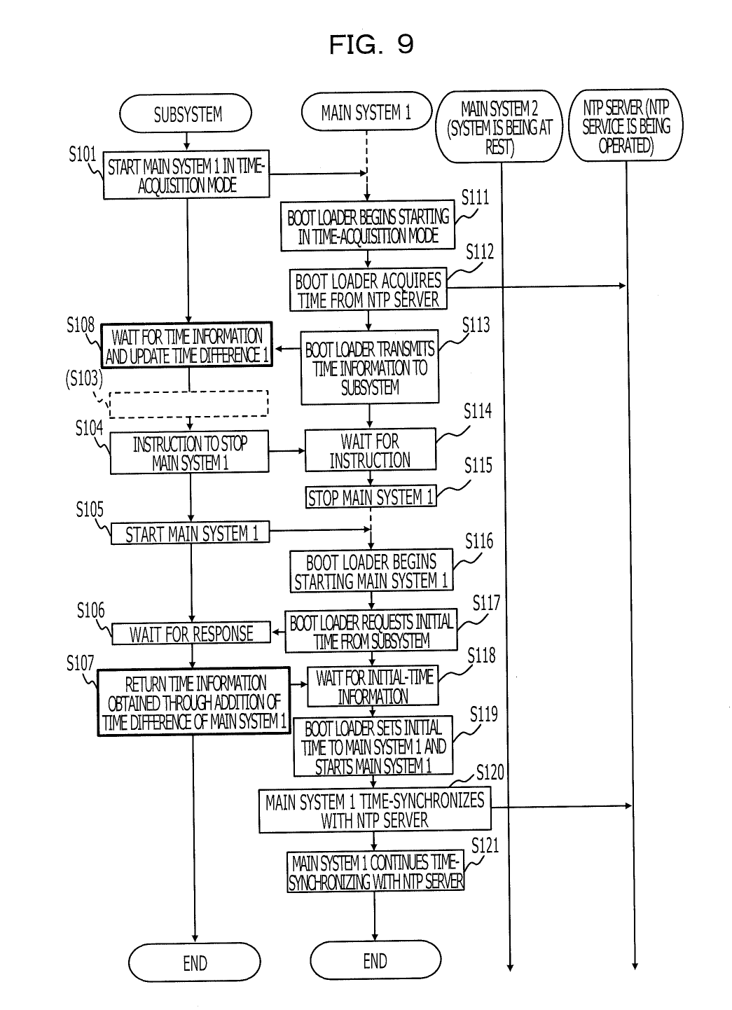

FIG. 9 illustrates an embodiment in which the processing procedures corresponding to operations (S102 and S103) that are illustrated in the main-system starting flow illustrated FIG. 5 are performed according to a different method. Since the processing procedures that are illustrated in FIG. 9 are the same as those illustrated in FIG. 5 except for the processing procedure corresponding to operation (S108), detailed descriptions of the processing procedures that are illustrated in FIG. 9 are omitted in this specification.

According to the main-system starting flow illustrated in FIG. 5, the main system 1 transmits information about the time synchronized with the NTP server to the subsystem (S113), and the subsystem revises the subsystem time and clears the time difference 1 (S103). In the present embodiment, however, the subsystem stores information about the time difference between the time of each of the main systems and that of the subsystem through the time-difference storage circuits 11-1 to 11-3. Therefore, the processing procedure corresponding to operation (S103) may be omitted as illustrated in FIG. 9.

According to a flow illustrated in FIG. 9, the main system 1 transmits the information about the time synchronized with that of the NTP server to the subsystem (S113), and the subsystem updates data of the time difference 1, the data being stored in the time-difference storage circuit 11-1, based on the time information transmitted from the main system 1 (S108). Since information about the time synchronized with that of the NTP server can be obtained by adding the updated time difference 1 to the time information of the subsystem, the subsystem performs processing procedures corresponding to operation (S104) and afterward without revising the subsystem time as operation (S103) illustrated in FIG. 5.

The subsystem restarts the main system 1 through the processing procedures corresponding to operations (S104 and S105) that are illustrated in FIG. 9, and waits for the initial-time request issued from the main system 1 (S106). Upon receiving the initial-time request issued to start the main system 1, the initial-time request being transmitted from the boot loader of the main system 1 (S117), the subsystem returns information about time obtained by adding the time difference 1 updated through operation (S108) to the time information of the subsystem, that is, information about the subsystem time revised through the addition of the time difference 1 to the main system 1 as the initial-time information (S107). After that, the main system 1 is started after the processing procedures corresponding to operations (S118 to S121) are performed, as is the case with FIG. 5.

In FIG. 9, the processing procedure corresponding to operation (S103) illustrated in FIG. 5, that is, the processing performed to revise the subsystem time based on the information about the time synchronized with the NTP server is omitted. However, the information about the time synchronized with that of the NTP server can be obtained by adding the time difference 1 updated through operation (S108) to the subsystem time. Therefore, the main system 1 can also be started as is the case with FIG. 5 through the processing procedures that are performed through the subsystem (S108, S107, etc.), the processing procedures being illustrated in FIG. 9.

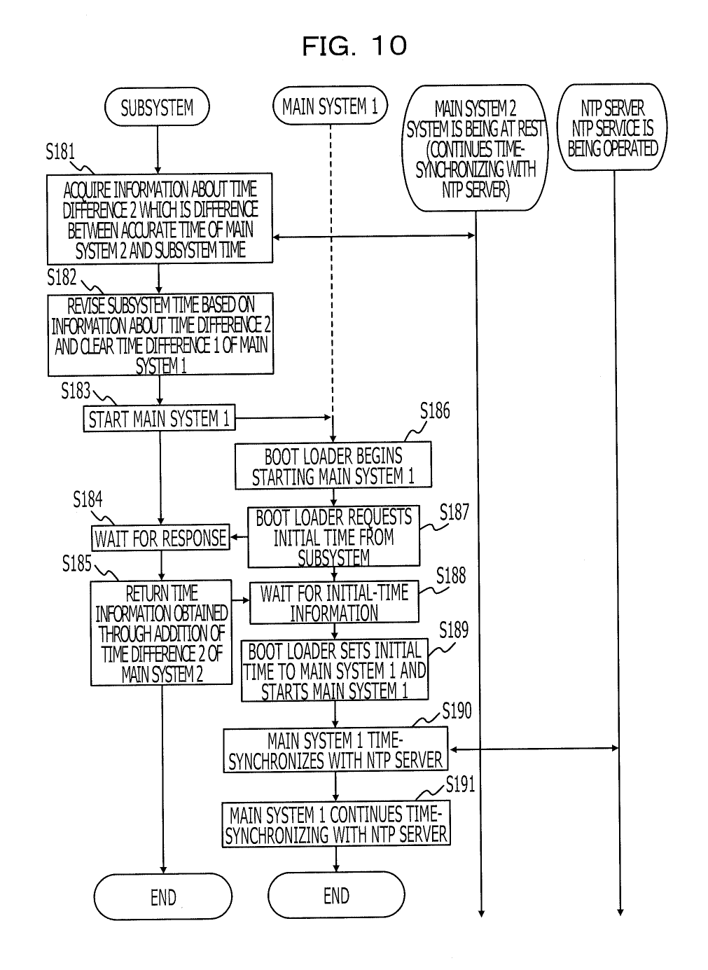

FIG. 10 illustrates an exemplary main-system starting flow according to the present embodiment, which is executed in circumstances that are different from those of FIGS. 5 and 9. In FIG. 10, the main system 2 is operating before the subsystem starts the main system 1, and the time of the main system 2 is synchronized with that of the NTP server, for example.

When the main system 2 continues time-synchronizing with the NTP server when the main system 1 is started through the subsystem, the subsystem can obtain the accurate time through the use of information about a time difference 2 which is the difference between the time of the main system 2 and that of the subsystem. Here, the time-difference information which is information about the difference between the time of each of the main systems and the subsystem time is stored in circuits (11-1 to 11-3) including registers or the like storing information about the time difference 1, the time difference 2, and a time difference 3, the circuits being provided in the subsystem.

The time-difference information will be described below. For example, it is arranged that each time the main system 2 time-synchronizes with the NTP server on a regular basis, the main system 2 transmits information about the time synchronized with that of the NTP server to the subsystem, and the time-difference-2 information stored in the time-difference-2 storage circuit 11-2 is updated. Accordingly, when the subsystem tries to start the main system 1 being at rest at some point in time, it becomes possible to revise the subsystem time based on the time-difference-2 information corresponding to the time of the operating main system 2, set the initial time synchronized with the time of the NTP server, and start the main system. The above-described arrangement will be described with reference to FIG. 10.

When starting the main system 1 through the subsystem in the state where the main system 2 is operating, where the time of the main system 2 is synchronized with that of the NTP server, the subsystem acquires the time-difference-2 information which is information about the difference between the time of the main system 2 and that of the subsystem in the first place (S181). The time-difference-2 information is updated when, for example, the main system 2 time-synchronizes with the NTP server on a regular basis.

When the subsystem acquires the time-difference-2 information generated based on information about the time synchronized with that of the NTP server as operation (S181) illustrated in FIG. 10, the subsystem revises the subsystem time based on the acquired time-difference-2 information and clears the time difference 1 of the main system 1 (S182). After that, the subsystem starts the main system 1 in the ordinary-start mode (S183) and waits for a response from the main system 1 (S184).

Upon being started in the ordinary-start mode (S186), the boot loader 41 of the main system 1 requests the initial-time information used to start the domain OS 50 from the subsystem (S187), and waits for a response from the subsystem (S188).

Upon receiving the initial-time request issued from the boot loader 41 of the main system 1, the subsystem returns information about time obtained by adding the time difference 1 to the revised subsystem time as the initial-time information of the main system 1 (S185). Since the time difference 1 is cleared as operation (S182), the processing performed to add the time difference 1 to the subsystem time as operation (S185) may be omitted. When omitting the processing corresponding to operation (S182) illustrated in FIG. 10, that is, the processing performed to revise the subsystem time based on information about the time synchronized with that of the NTP server, information about time obtained by adding the time difference 2 to the subsystem time can be returned to the main system 1 as the initial time as operation (S185), as is the case with the embodiment illustrated in FIG. 9.

Upon acquiring the initial-time information transmitted from the subsystem, the boot loader 41 of the main system 1 sets the initial time to the domain OS 50 of the main system 1 and starts the domain OS 50 as operation (S189) illustrated in FIG. 10, as is the case with the processing performed as operation (S119) and afterward illustrated in FIG. 5. When the boot loader 41 starts the domain OS 50, the main system 1 time-synchronizes with the NTP server (S190), and continues time-synchronizing with the NTP server on a regular basis (S191).

When the main system 2 time-synchronizes with the NTP server before the subsystem starts the main system 1 as illustrated in FIG. 10, the subsystem can acquire the accurate time information based on information about the time difference 2 which is the difference between the time of the main system 2 and the subsystem time and start the main system 1. It can be determined whether or not the main system 2 time-synchronizes with the NTP server by referring to information about the date and time of updating the time difference 2, the information being stored in addition to the time-difference-2 information and studying whether or not the time difference 2 is updated during a predetermined time period starting from the reference time.

FIG. 10 illustrates the example where only the main system 2 is operated while being time-synchronized with the NTP server. However, in the case where a plurality of the main systems is operated while being time-synchronized with the NTP server, the subsystem can also start the main system being at rest based on time-difference information provided for the time of each of the main systems. In that case, the subsystem time can be revised to more accurate time based on time-difference information updated to the latest time of at least two pieces of the time-difference information corresponding to at least two main systems that are being operated. Thus, the subsystem includes circuits (e.g., the circuits 11-1 to 11-3 that are illustrated in FIG. 1) storing the time-difference information corresponding to the at least two main systems and the main systems update the time-difference information stored in the individual circuits each time the main systems time-synchronize with the NTP server. Consequently, the subsystem can acquire more accurate time.

Further, when the main systems are operating, an error often occurs between the times of the main systems in the case where the main systems do not time-synchronize with the NTP server over a predetermined time period or more. For example, when the time-difference information corresponding to each of the main systems is not updated over the predetermined time period or more, the subsystem may not be able to acquire the accurate time. In that case, the subsystem starts the boot loader 41 of the main system for starting in the time-acquisition mode in the first place, as is the case with the above-described flow illustrated in FIG. 5. Then, the main system may be started again in the ordinary-start mode after the subsystem acquires accurate time information. Thus, the subsystem can acquire the accurate time and start the main system even though the NTP server is not connected to the management LAN 7 connected to the subsystem managing the main system. That is, the function of accessing the NTP server is provided for the boot loader 41 of the main system so that the subsystem can acquire the accurate time through the use of the above-described function, and start the main system based on the acquired accurate time as the initial time. Further, the time-difference information corresponding to each of the main systems is stored, each of the main systems is made to update the time-difference information, and the subsystem time is revised based on the latest updated time-difference information so that the accuracy of the subsystem time is increased.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media, which may be non-transitory. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc - Read Only Memory), and a CD-R (Recordable)/RW. An example of communication media includes a carrier-wave signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information-processing apparatus, comprising:
a main system that presents a function as the information-processing apparatus and acquires time information from a time server measuring time, the time information being synchronized with time of the time server; and
a subsystem that manages the main system,
wherein the main system starts up in a start mode, which is either an ordinary-start mode provided to present the function as the information-processing apparatus or a specified mode provided to acquire the synchronized time information from the time server, based on a start-mode instruction issued from the subsystem, and
the subsystem starts up the main system in the specified mode when starting the main system from rest, revises management-system time obtained from a clock device which is controlled by the subsystem based on the synchronized time information acquired through the main system started in the specified mode, and restarts the main system in the ordinary-start mode by determining the revised management-system time to be an initial time used to start the main system.

2. The information-processing apparatus according to claim 1,
wherein the information-processing apparatus includes a plurality of main systems including a main system that can access the time server,
wherein the subsystem stores information about a difference between a time of each main system and the management system time as time-difference information corresponding to the main system, and
wherein, when a main system which is time-synchronized with the time server is operating when the subsystem starts a main system from rest, the subsystem revises the management system time of the subsystem based on time-difference information corresponding to the main system operating in synchronization with the time server without starting the main system from rest in the specified mode, determines the revised management system time as the initial time, and starts the main system from rest in the ordinary-start mode.

3. The information-processing apparatus according to claim 1,
wherein when the subsystem starts a main system from rest in the state in which an operating main system does not acquire the synchronized time information from the time server over a predetermined time period, the subsystem starts the main system from rest in the specified mode, acquires the synchronized time information and revises the management system time based on acquired synchronized time information, determines the revised management system time to be the initial time, and restarts the main system in the ordinary-start mode, and
wherein when the subsystem starts the main system from rest in the state in which the operating main system has acquired the synchronized time information from the time server within the predetermined time period, the subsystem revises the management system time of the subsystem based on time-difference information corresponding to the operating main system, determines the revised management system time to be the initial time, and starts the main system from rest in the ordinary-start mode.

4. The information-processing apparatus according to claim 1,
wherein the main system is started through a boot loader which is a program provided to boot an operating system making the main system operate,
wherein the boot loader of the main system includes a time-server access unit for accessing the time server and acquiring the synchronized time information, and
wherein the main system started in the specified mode through the subsystem acquires the synchronized time information through the time-server access unit.

5. A method of starting an information-processing apparatus including a main system that presents a function as the information-processing apparatus and that acquires time information from a time server measuring time, the time information being synchronized with time of the time server, and a subsystem that manages the main system, the method comprising:
starting the main system from rest in a specified mode provided to acquire time information synchronized with time of the time server from the time server through the subsystem;
revising management-system time obtained from a clock device controlled through the subsystem based on the synchronized time information acquired through the main system started in the specified mode;
determining the revised management-system time to be an initial time used to start the main system; and
restarting the main system in ordinary-start mode provided to present the function as the information-processing apparatus through the subsystem.

6. A computer-readable recording medium storing a program for causing a computer to execute starting an information-processing apparatus including a main system that presents a function as the information-processing apparatus and that acquires time information from a time server measuring time, the time information being synchronized with time of the time server, and a subsystem that manages the main system, the process comprising:
starting the main system from rest in a specified mode provided to acquire time information synchronized with time of the time server from the time server through the subsystem;
revising management-system time obtained from a clock device controlled through the subsystem based on the synchronized time information acquired through the main system started in the specified mode;
determining the revised management-system time to be an initial time used to start the main system; and
restarting the main system in ordinary-start mode provided to present the function as the information-processing apparatus through the subsystem.
